(19) United States
(12) Patent Application Publication
(10) Pub. No.: US 2025/0290556 A1
(43) Pub. Date: Sep. 18, 2025

(54) ACTIVE VIBRATION DAMPING DEVICE

(71) Applicant: HONDA MOTOR CO., LTD., Tokyo (JP)

(72) Inventors: Yuho ITO, Wako-shi (JP); Toshio INOUE, Wako-shi (JP)

(21) Appl. No.: 19/059,812

(22) Filed: Feb. 21, 2025

(30) Foreign Application Priority Data
Mar. 15, 2024 (JP) 2024-041199

(51) Int. Cl. F16F 13/10; B62D 27/04; F16F 13/30

(52) U.S. Cl. CPC F16F 13/10; F16F 13/305; B62D 27/04; F16F 2222/12; F16F 2224/045; F16F 2228/066; F16F 2230/18

(57) ABSTRACT

An active vibration control device includes: an outer cylinder; an inner cylinder arranged on an inner peripheral side of the outer cylinder; an electromagnetic coil; a first magnetic body and a second magnetic body; a first fluid chamber filled with a magneto-rheological fluid; a second fluid chamber adjacent to the first fluid chamber and filled with a fluid; an outer cylinder flange; and an inner cylinder flange arranged to be separated from the outer cylinder flange in an axial direction, the first fluid chamber and the second fluid chamber are partitioned from each other in the axial direction by a flexible member, the second fluid chamber is formed to be sandwiched between the inner cylinder flange and the outer cylinder flange, and portions of the first fluid chamber form flow passages of the magneto-rheological fluid that are located on a magnetic circuit.

### CROSS REFERENCE TO RELATED APPLICATION

This application is based upon and claims priority from the Japanese Patent Application No. 2024-041199, filed on Mar. 15, 2024, the entire contents of which are incorporated herein by reference.

### BACKGROUND OF THE INVENTION

### 1. Field of the Invention

The present invention relates to an active vibration control device.

### 2. Description of the Related Art

In recent years, efforts to provide access to a transportation system that is sustainable and friendly to vulnerable people such as the elderly, the handicapped, and children among traffic participates are becoming active. In order to achieve this, we have focused on research and development for further improving safety and usability of traffic through development relating to occupant comfort of a vehicle.

There has been conventionally proposed an active vibration control device that is used in a subframe mount, a suspension bush, or the like to improve occupant comfort of a vehicle by suppressing sound and vibration in a vehicle cabin (for example, see JP2021-71117A). Specifically, in this active vibration control device, two fluid chambers filled with a magneto-rheological fluid are connected to each other by flow passages, and the active vibration control device includes an exciting coil that forms a magnetic circuit in a direction intersecting the flow passages. According to this active vibration control device, the magneto-rheological fluid flows from one fluid chamber to the other fluid chamber through the flow passages depending on the magnitude of inputted vibration amplitude. In this case, the active vibration control device controls the flow of the magneto-rheological fluid by varying the density of a magnetic flux generated by the exciting coil. The active vibration control device thereby exhibits a damping characteristic that is adjustable depending on the magnitude of inputted vibration amplitude.

### SUMMARY OF THE INVENTION

In the conventional active vibration control device (for example, see JP2021-71117A), the capacities of the fluid chambers can be increased to improve responsiveness to the inputted vibration amplitude. However, this increases a filling amount of the magneto-rheological fluid, including a magnetic powder and being relatively heavy and expensive, in the fluid chambers. This causes new problems of an increase in the manufacturing cost of the active vibration control device and an increase in the weight of a vehicle in which the active vibration control device is mounted. Moreover, in the active vibration control device, when a usage amount of the magneto-rheological fluid increases, an absolute amount of the precipitating magnetic powder included in the magneto-rheological fluid also increases, and the performance of the active vibration control device may decrease.

An object of the present invention is to provide an active vibration control device that can improve responsiveness to an inputted external force such as vibration or load without increasing the capacity of a fluid chamber filled with a magneto-rheological fluid and that can also suppress a performance decrease caused by precipitation of a magnetic powder in the magneto-rheological fluid in the fluid chamber. Moreover, the present invention contributes furthermore to development of a sustainable transportation system.

The present invention is an active vibration control device comprising: an outer cylinder; an inner cylinder arranged on an inner peripheral side of the outer cylinder; a magnetic field generator configured to generate a magnetic field; a magnetic body forming a magnetic circuit created by the magnetic field; a first fluid chamber filled with a magneto-rheological fluid; a second fluid chamber adjacent to the first fluid chamber and filled with a fluid; an outer cylinder flange extending outward in a radial direction from one end of the outer cylinder in an axial direction; and an inner cylinder flange extending outward in the radial direction from the inner cylinder and arranged to be separated from the outer cylinder flange in the axial direction, the first fluid chamber and the second fluid chamber are partitioned from each other in the axial direction by a flexible member, the second fluid chamber is formed to be sandwiched between the inner cylinder flange and the outer cylinder flange, and portions of the first fluid chamber form flow passages of the magneto-rheological fluid that are located on the magnetic circuit.

According to the active vibration control device of the present invention, it is possible to improve responsiveness to an inputted external force such as vibration or load without increasing the capacity of the fluid chamber filled with the magneto-rheological fluid and to suppress a performance decrease caused by precipitation of a magnetic powder in the magneto-rheological fluid in the fluid chamber.

### BRIEF DESCRIPTION OF THE DRAWINGS

FIG. 1 is an overall perspective view of a subframe including an active vibration control device according to an embodiment of the present invention.

FIG. 2 is an overall perspective view of the active vibration control device according to the embodiment of the present invention.

FIG. 3 is an exploded perspective view of the active vibration control device according to the embodiment of the present invention.

FIG. 4A is a partial perspective view of the active vibration control device including a IVA-IVA cross section of FIG. 2.

FIG. 4B is a partial perspective view of the active vibration control device including a IVB-IVB cross section in FIG. 2.

FIG. 4C is a partial perspective view of the active vibration control device including a IVC-IVC cross section in FIG. 2.

FIG. 5A is a partial perspective view of the active vibration control device including a VA-VA cross section in FIG. 2.

FIG. 5B is a partial perspective view of the active vibration control device including a VB-VB cross section in FIG. 2.

FIG. 5C is a partial perspective diagram of the active vibration control device including a VC-VC cross section in FIG. 2.

FIG. 6A is an operation explanation view of the active vibration control device in the case where vibration or the like is inputted in the axial direction of the active vibration control device.

FIG. 6B is an operation explanation view of the active vibration control device showing how a magneto-rheological fluid flows in first fluid chambers in the case where vibration or the like is inputted in the axial direction of the active vibration control device.

FIG. 6C is an operation explanation view of the active vibration control device in the case where vibration or the like is inputted in such a direction that the inner cylinder of the active vibration control device is twisted relative to the outer cylinder.

FIG. 6D is an operation explanation view of the active vibration control device showing how a magnetic circuit is formed by a magnetic field generated by an electromagnetic coil.

FIG. 6E is a schematic diagram showing operations of a magnetic powder in the case where the magnetic field is applied to orifices of the first fluid chambers.

FIG. 7A is an arrangement diagram of second fluid chambers and air chambers in the active vibration control device according to a first modified example.

FIG. 7B is an arrangement diagram of the first fluid chambers in the active vibration control device according to the first modified example.

FIG. 8 is a configuration explanation diagram of the active vibration control device according to a second modified example.

FIG. 9A is a vertical cross-sectional view of the active vibration control device according to a third modified example.

FIG. 9B is an exploded perspective view of the active vibration control device according to the third modified example.

### DETAILED DESCRIPTION OF THE EMBODIMENTS

Next, a mode for implementing (embodiment of) an active vibration control device of the present invention is explained in detail with reference to the drawings as appropriate.

Although an active vibration control device applied to a subframe of a vehicle is explained below as an example, the present invention is not limited to this, and may be applied to a sound-control vibration-control device for a vehicle such as, for example, a mount bush arranged between a vehicle frame and a member connected to the vehicle frame.

First, an overall configuration of the subframe to which the active vibration control device of the present embodiment is applied is explained, and then the active vibration control device is explained in further detail.

### <<Subframe>>

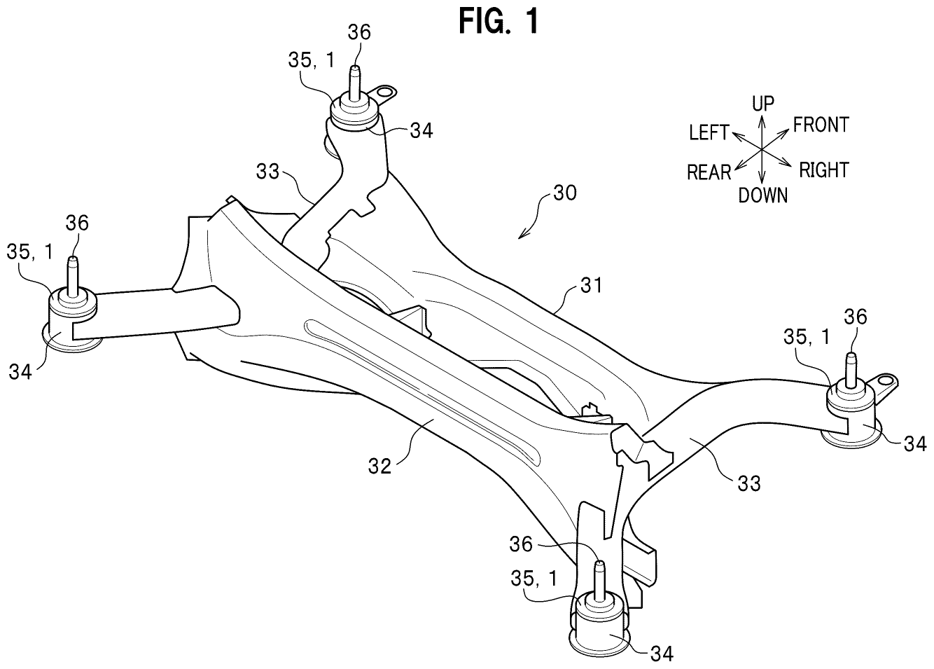

FIG. 1 is an overall perspective view of a subframe including the active vibration control device according to the embodiment of the present invention. Note that directions of up, down, left, right, front, and rear in the following explanation are based on the directions of the arrows in FIG. 1 matching directions of up, down, left, right, front, and rear of a vehicle.

The subframe 30 shown in FIG. 1 is attached to the vehicle body side such as rear side frames (illustration omitted) of the vehicle, and has a structure configured to support suspension arms (illustration omitted).

As shown FIG. 1, the subframe 30 has a number-sign shape in a plan view.

Specifically, the subframe 30 includes a front cross member 31 extending in a vehicle width direction (left-right direction), a rear cross member 32 extending in the vehicle width direction (left-right direction) behind the front cross member 31, and paired left and right side members 33 extending in a front-rear direction and connected to both end portions of the front cross member 31 and the rear cross member 32 in the vehicle width direction.

Each of the side members 33 is curved to protrude inward in the vehicle width direction in the plan view. Specifically, each of the side members 33 is curved such that the side member 33 is shifted outward in the vehicle width direction while extending forward from a joining portion with the front cross member 31. Moreover, each of the side members 33 is curved such that the side member 33 is shifted outward in the vehicle width direction while extending rearward from a joining portion with the rear cross member 32.

A collar member 34 is attached to each of front end portions and rear end portions of the side members 33 by welding or the like.

Each of the collar members 34 is formed of a cylindrical body that is open on the upper and lower sides. Moreover, a bush 35 is inserted inside each collar member 34. The bush 35 is fixed to the collar member 34 by welding or the like.

Support shafts 36 of the respective bushes 35 protruding upward are fastened to the rear side frames (illustration omitted). The subframe 30 is thereby supported on the rear side frames (illustration omitted) via the bushes 35 in a floating manner.

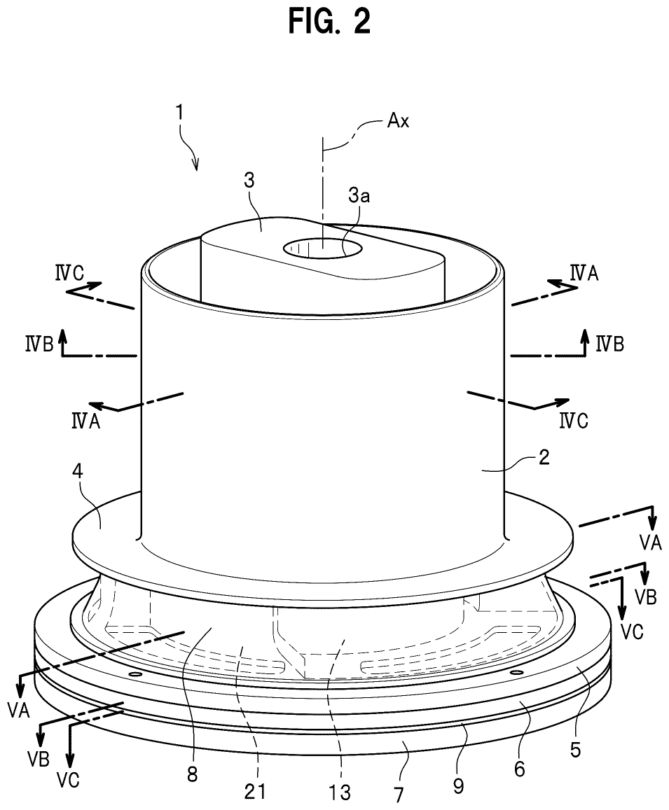

Each bush 35 is the active vibration control device of the present embodiment, and is referred to as active vibration control device 1 below. Note that each support shaft 36 is supported by being inserted into a hole portion 3a (see FIG. 2) of an inner cylinder 3 (see FIG. 2) to be described later.

### <<Active Vibration Control Device>>

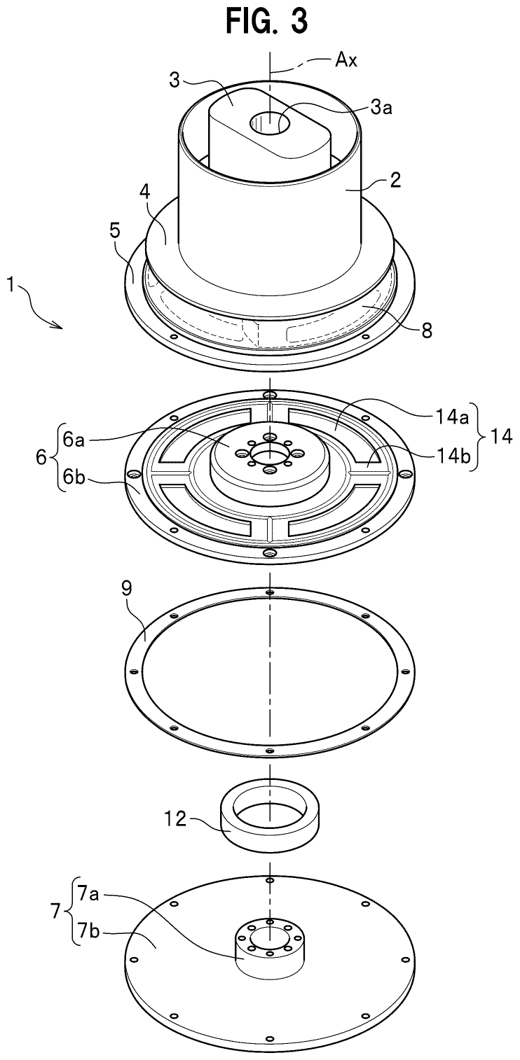

FIG. 2 is an overall perspective view of the active vibration control device 1 according to the present embodiment. FIG. 3 is an exploded perspective view of the active vibration control device 1. Note that second fluid chambers 21 and air chambers 13 defined inside an elastic body 8 are shown by hidden lines (dotted lines) in FIG. 2.

As shown in FIG. 2, the active vibration control device 1 has a circular-column outer shape.

In the following explanation, a direction along the axis Ax of this active vibration control device 1 with the circular-column shape is simply referred to as “axial direction” in some cases. Moreover, a radial direction in the active vibration control device 1 is simply referred to as “radial direction”, and a circumferential direction in the active vibration control device 1 is simply referred to as “circumferential direction” in some cases.

As shown in FIG. 2, the active vibration control device 1 includes an outer cylinder 2, an outer cylinder flange 4, the inner cylinder 3, an inner cylinder flange 5, and the elastic body 8.

Moreover, as shown in FIG. 3, the active vibration control device 1 further includes a flexible member 14, a first magnetic body 6, a second magnetic body 7, an electromagnetic coil 12 (magnetic field generator), and a spacer 9.

As shown in FIG. 2, the outer cylinder 2 is formed of a cylindrical body.

The outer cylinder flange 4 is formed of an annular plate body that extends outward in the radial direction from one end of the outer cylinder 2 in the axis Ax direction in a flange shape. The outer cylinder flange 4 is shaped integrally with the outer cylinder 2.

As shown in FIG. 2, the inner cylinder 3 is arranged on the inner peripheral side of the outer cylinder 2.

The outer shape of the horizontal cross section of the inner cylinder 3 is an oval track shape. Specifically, the horizontal cross section of the inner cylinder 3 has a stadium outer shape formed of paired linear portions that extend parallel to each other and paired arcs connected to both ends of the paired linear portions.

The horizontal cross section of the hole portion 3a formed inside the inner cylinder 3 has a true circle shape. Specifically, the thickness of the inner cylinder 3 in a longer direction is larger than that in a shorter direction.

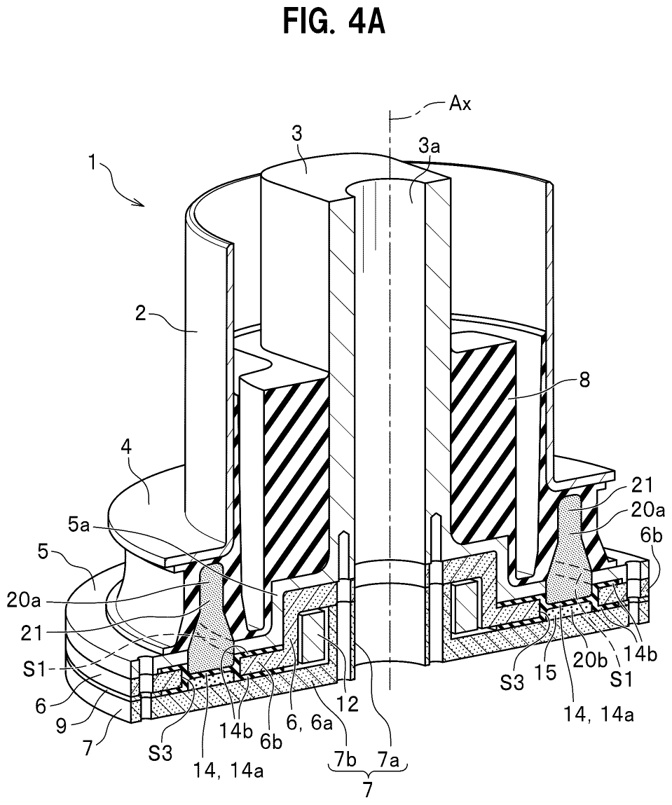

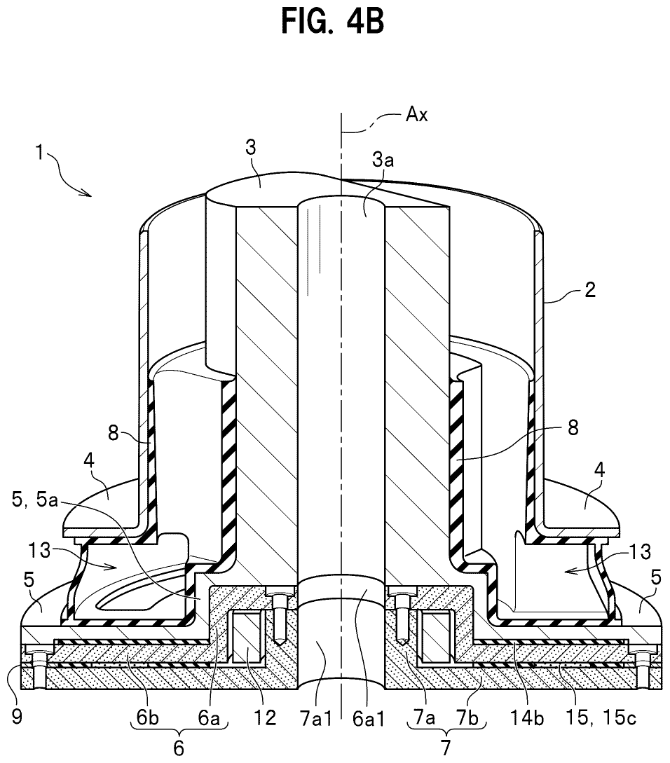

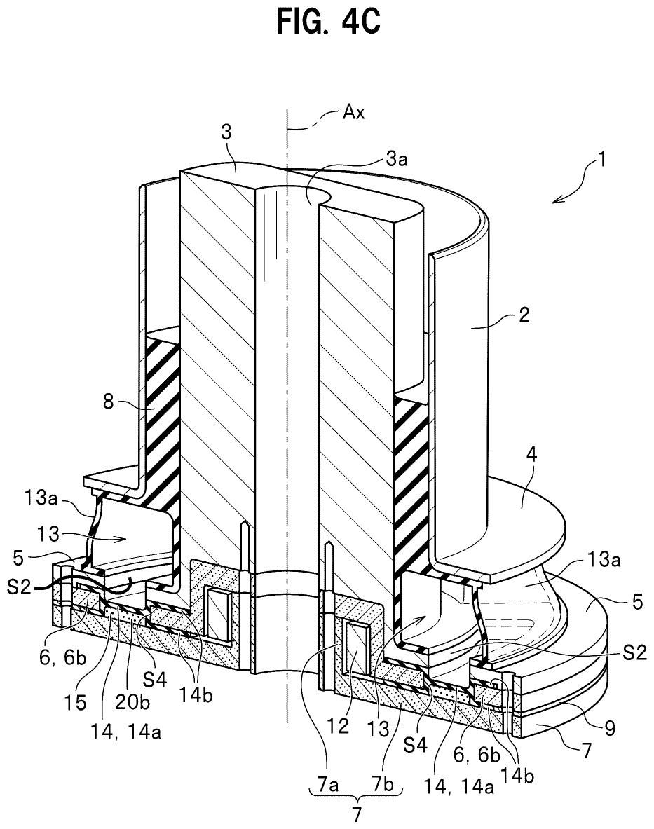

FIG. 4A is a partial perspective view of the active vibration control device including a IVA-IVA cross section in FIG. 2. FIG. 4B is a partial perspective view of the active vibration control device including a IVB-IVB cross section in FIG. 2. FIG. 4C is a partial perspective view of the active vibration control device including a IVC-IVC cross section in FIG. 2.

As shown in FIG. 4A, the inner cylinder flange 5 is formed of an annular plate body extending outward in the radial direction from one end of the inner cylinder 3 in the axis Ax direction in a flange shape. The inner cylinder flange 5 is shaped integrally with the inner cylinder 3.

The inner cylinder flange 5 is arranged to be separated from the outer cylinder flange 4 in the axial direction of the inner cylinder 3.

Moreover, the inner cylinder flange 5 is provided with a step wall 5a in the middle of outward extension in the radial direction. Specifically, the inner cylinder flange 5 is bent in a direction away from the outer cylinder flange 4 in the middle of outward extension in the radial direction to extend in the axial direction, and is then further bent to extend outward in the radial direction. A protruding portion 6a of the first magnetic body 6 to be described later is fitted on the inner side of the step wall 5a in the radial direction.

Furthermore, as shown in FIG. 4A, slits S1 are formed in the inner cylinder flange 5 such that the second fluid chambers 21 to be described later face the flexible member 14. These slits S1 extend along the circumferential direction of the inner cylinder flange 5 to correspond to the second fluid chambers 21.

Moreover, as shown in FIG. 4C, slits S2 are formed in the inner cylinder flange 5 such that the air chambers 13 to be described later face the flexible member 14. These slits S2 extend along the circumferential direction of the inner cylinder flange 5 to correspond to the air chambers 13.

The outer cylinder 2, the inner cylinder 3, the outer cylinder flange 4, and the inner cylinder flange 5 are assumed to be made of a non-magnetic material.

An aluminum alloy, a non-ferritic SUS, copper, and the like can be given as examples of the non-magnetic material, but are not limited to these.

As shown in FIG. 4A, the elastic body 8 made of synthetic rubber is vulcanized to bond the outer cylinder flange 4 and the inner cylinder flange 5 to each other, and the outer cylinder flange 4 and the inner cylinder flange 5 are integrated with each other.

Moreover, as shown in FIG. 4C, the elastic body 8 is vulcanized to bond the outer cylinder 2 and the inner cylinder 3 to each other. Specifically, the elastic body 8 is vulcanized to bond each of outer surfaces of the portions of the inner cylinder 3 with a large thickness and an inner peripheral surface of the outer cylinder 2 facing this outer surface to each other. In other words, in terms corresponding to the horizontal cross-sectional shape of the inner cylinder 3 described above, the elastic body 8 is vulcanized to bond each of the outer surfaces forming the arc portions of the oval track shape and the inner peripheral surface of the outer cylinder 2 to each other.

Note that, as shown in FIGS. 4A and 4B, flat outer surfaces of the inner cylinder 3 that form the linear portions of the oval track shape are not directly bonded to the inner peripheral surface of the outer cylinder 2 by the vulcanization bonding of the elastic body 8.

Specifically, the joining portion of the inner peripheral surface of the outer cylinder 2 and the outer surface of the inner cylinder 3 by the elastic body 8 is limited to two locations that are away from each other by a phase of 180 degrees in a view in the axis Ax direction.

As shown in FIG. 4A, the elastic body 8 is vulcanized to bond the outer cylinder flange 4 and the inner cylinder flange 5 to each other with the outer cylinder flange 4 and the inner cylinder flange 5 separated away from each other by a predetermined distance.

Moreover, as shown in FIG. 4A, the elastic body 8 defines the second fluid chambers 21 between the outer cylinder flange 4 and the inner cylinder flange 5.

Furthermore, as shown in FIG. 4C, the elastic body 8 defines the air chambers 13 between the outer cylinder flange 4 and the inner cylinder flange 5.

Next, the second fluid chambers 21 (see FIG. 4A) and the air chambers 13 (see FIG. 4C) are explained.

As shown in FIG. 4A, each second fluid chamber 21 is formed of a space elongating in the axial direction in a cross-sectional view traversing the second fluid chamber 21 in the radial direction. Specifically, the cross-sectional shape of the second fluid chamber 21 is formed such that the width in the radial direction gradually increases while the second fluid chambers 21 extends from the outer cylinder flange 4 side toward the inner cylinder flange 5 side.

Moreover, as shown in FIG. 4A, the second fluid chambers 21 face the flexible member 14 through the slits S1 formed in the inner cylinder flange 5.

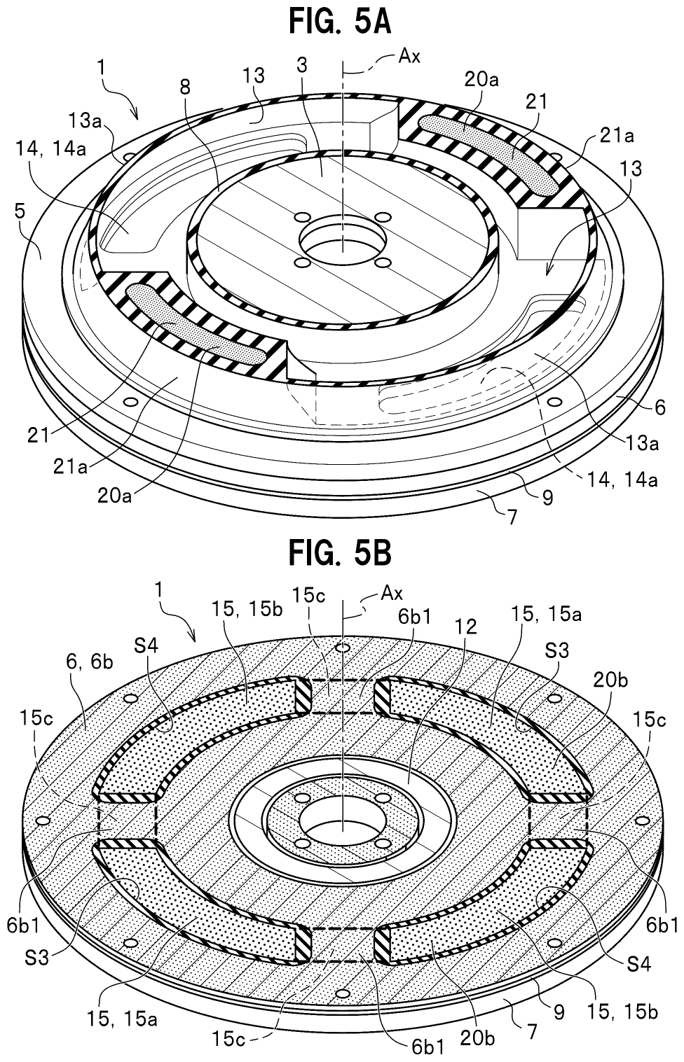

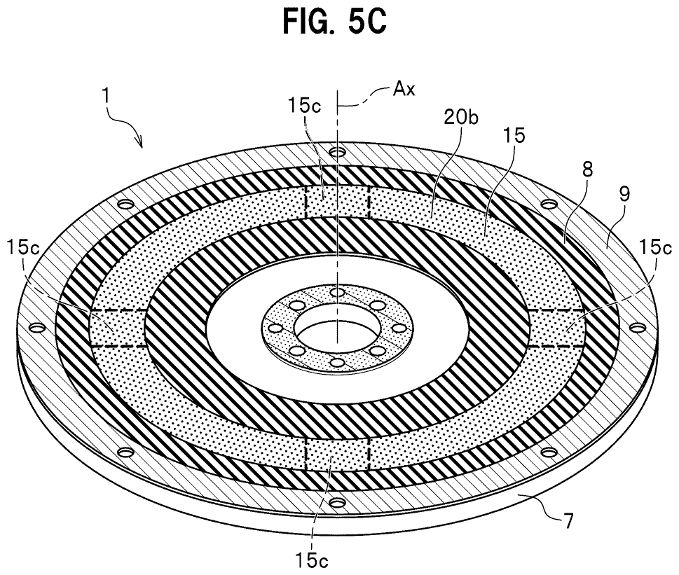

FIG. 5A is a partial perspective view of the active vibration control device 1 including a VA-VA cross section in FIG. 2.

As shown in FIG. 5A, two second fluid chambers 21 are formed in the circumferential direction of the inner cylinder flange 5. Specifically, the second fluid chambers 21 are arranged opposite to each other across the axis Ax. In other words, the second fluid chambers 21 are arranged away from each other by a phase of 180 degrees in the circumferential direction.

In the present embodiment, the second fluid chambers 21 extend in the circumferential direction in an arc shape.

As shown by shaded portions in FIGS. 4A and 5A, the second fluid chambers 21 as described above are filled with a fluid 20a being a medium that transmits vibration and the like. For example, a publicly-known hydraulic oil such as a silicone oil or an ester oil can be preferably used as the fluid 20a.

Next, the air chambers 13 (see FIG. 4C) are explained.

As shown in FIG. 4C, the air chambers 13 are defined by walls with a thickness smaller than the thickness of the elastic body 8 defining the second fluid chambers 21 (see FIG. 4A).

As shown in FIG. 5A, two air chambers 13 are arranged adjacent to the second fluid chambers 21 in the circumferential direction of the active vibration control device 1. Specifically, the air chambers 13 and the second fluid chambers 21 are alternately arranged in the circumferential direction of the active vibration control device 1.

Then, as shown in FIG. 4C, the air chambers 13 face the flexible member 14 through the above-mentioned slits S2 formed in the inner cylinder flange 5.

As shown in FIG. 5A, connection walls 13a are formed on the outer peripheral side of the air chambers 13 configured as described above to connect outer peripheral walls 21a of the adjacent second fluid chambers 21 to each other in the circumferential direction. As shown in FIG. 4C, the connection walls 13a extend in the circumferential direction on the outer peripheral side of the flexible member 14, and cover the air chambers 13 from the outer peripheral side.

Moreover, as shown in FIG. 5A, the connection walls 13a are formed in a film shape made of the elastic body 8 with a smaller thickness than the thickness of the outer peripheral walls 21a of the second fluid chambers 21.

Furthermore, as shown in FIG. 4C, the air chambers 13 are formed as closed spaces between the outer cylinder flange 4 and the inner cylinder flange 5 in the portions where the outer cylinder 2 and the inner cylinder 3 are bonded to each other by the vulcanization bonding of the elastic body 8.

Meanwhile, as shown in FIG. 4B, the air chambers 13 are opened to the atmosphere via spaces between the outer cylinder 2 and the inner cylinder 3 in the portions where the outer cylinder 2 and the inner cylinder 3 are not bonded to each other by the vulcanization bonding of the elastic body 8.

Next, the flexible member 14 (see FIG. 3) and the first magnetic body 6 (see FIG. 3) supporting this flexible member 14 are explained.

First, the first magnetic body 6 is explained.

The first magnetic body 6 is made of, for example, iron, cobalt, nickel, or an alloy of any of these metals.

As shown in FIG. 4B, the first magnetic body 6 has a hat shape. Specifically, the first magnetic body 6 includes the protruding portion 6a that is fitted inside the step wall 5a of the inner cylinder flange 5 and a disc shaped flange portion 6b that corresponds to a hat-shaped flange portion.

As shown in FIG. 4B, an opening 6a1 is formed in the protruding portion 6a to correspond to the hole portion 3a of the inner cylinder 3.

As shown in FIG. 4A, slits S3 are formed in the flange portion 6b of the first magnetic body 6 to correspond to the slits S1 of the inner cylinder flange 5.

Moreover, as shown in FIG. 4C, slits S4 are formed in the flange portion 6b of the first magnetic body 6 to correspond to the slits S2 of the inner cylinder flange 5.

FIG. 5B is a partial perspective view of the active vibration control device including a VB-VB cross section in FIG. 2.

As shown in FIG. 5B, the arc-shaped slits S3 corresponding to the second fluid chambers 21 (see FIG. 5A) and the arc-shaped slits S4 corresponding to the air chambers 13 (see FIG. 5A) are formed in the flange portion 6b of the first magnetic body 6 to be alternately arranged side by side in the circumferential direction via partition portions 6b1.

Note that reference sign 15c in FIG. 5B denotes orifices of first fluid chambers 15 formed between the partition portions 6b1 and a flange portion 7b of the second magnetic body 7 to be described later. The orifices 15c shown by hidden lines (dotted lines) in FIG. 5B are explained later in detail.

Next, the flexible member 14 (see FIG. 3) is explained.

The flexible member 14 is assumed to be a member made of synthetic rubber.

As shown in FIG. 3, the flexible member 14 includes a flexible member main body 14a and a supporting portion 14b that causes the flexible member main body 14a to be supported on the first magnetic body 6.

As shown in FIGS. 4A and 4C, the flexible member main body 14a is formed in a film shape that is thin in the axial direction and that extends in the radial direction and the circumferential direction.

As shown in FIG. 4A, the flexible member main body 14a is arranged to block the slits S3 of the first magnetic body 6 (flange portion 6b). Moreover, as shown in FIG. 4C, the flexible member main body 14a is arranged to block the slits S4 of the first magnetic body 6 (flange portion 6b).

Specifically, as shown in FIGS. 4A and 4C, the flexible member main body 14a is shaped integrally with the supporting portion 14b to be located at the middle of the flange portion 6b in the plate thickness direction thereof.

As shown in FIGS. 4A and 4C, the supporting portion 14b is formed of film bodies that are vulcanized and bonded to the flange portion 6b to sandwich the flange portion 6b from the front and back sides thereof.

Moreover, as shown in FIGS. 4A to 4C, the supporting portion 14b is formed to cover substantially the entire front and back sides of the flange portion 6b excluding an outer peripheral edge of the flange portion 6b and portions where the orifices 15c (see FIG. 4B) of the first fluid chambers 15 (see FIG. 4B) to be described later are formed.

Portions of the supporting portion 14b spreading, respectively, on the front and back sides of the flange portion 6b are integrally joined at inner peripheral edges of the slits S3 (see FIG. 4A) and inner peripheral edges of the slits S4 (see FIG. 4C), and support the flexible member main body 14a (see FIGS. 4A and 4C).

Next, the second magnetic body 7 (see FIG. 3) is explained.

The second magnetic body 7 is formed of, for example, iron, cobalt, nickel, or an alloy of any of these metals.

As shown in FIG. 3, the second magnetic body 7 includes a cylinder portion 7a and the flange portion 7b extending outward in the radial direction from one end of the cylinder portion 7a in the axial direction. As shown in FIG. 3, the outer diameter of the flange portion 7b is formed to be the same as the outer diameter of the flange portion 6b in the first magnetic body 6.

As shown in FIG. 4B, a hole portion 7a1 communicating with the hole portion 3a of the inner cylinder 3 via the opening 6a1 of the first magnetic body 6 is formed inside the cylinder portion 7a.

Moreover, as shown in FIG. 4B, an annular space in which the electromagnetic coil 12 (magnetic field generator) is housed is formed between the protruding portion 6a of the first magnetic body 6 and a corner portion formed by the cylinder portion 7a and the flange portion 7b of the second magnetic body 7.

As shown in FIGS. 4A to 4C, the flange portion 6b of the first magnetic body 6 and the flange portion 7b of the second magnetic body 7 are magnetically insulated from each other by the supporting portion 14b of the flexible member 14. However, as shown in FIG. 4B, the supporting portion 14b is omitted in the portions where the orifices 15c of the first fluid chambers 15 to be explained next are formed.

As shown in FIGS. 4A and 4C, the first fluid chambers 15 are formed between the flange portion 7b of the second magnetic body 7 and the flexible member main body 14a.

Specifically, the first fluid chambers 15 shown in FIG. 5B include first fluid chambers 15a adjacent to the second fluid chambers 21 (see FIG. 4A) in the axial direction via the flexible member main body 14a (see FIG. 4A) and first fluid chambers 15b formed to be adjacent to the air chambers 13 (see FIG. 4C) in the axial direction via the flexible member main body 14a (see FIG. 4C).

Note that the first fluid chambers 15b correspond to “first fluid chambers not adjacent to the second fluid chambers” described in the scope of claims.

Moreover, as shown in FIG. 4B, the orifices 15c of the first fluid chambers 15 are formed between the second magnetic body 7 and portions of the flange portion 6b of the first magnetic body 6 corresponding to the partition portions 6b1 (see FIG. 5B).

FIG. 5C is a partial perspective diagram of the active vibration control device including a VC-VC cross section in FIG. 2.

As shown in FIG. 5C, the first fluid chambers 15 are continuous in an annular shape on the cross section including the orifices 15c.

Moreover, as described above, the first fluid chambers 15a and the first fluid chambers 15b shown in FIG. 5B are connected to one another at the orifices 15c.

The first fluid chambers 15 as described above are filled with a magneto-rheological fluid 20b. A publicly-known magneto-rheological fluid (MRF) in which a magnetic powder is dispersed in a mineral oil, a synthetic oil, or the like, a magneto-rheological compound (MRC), or the like can be preferably used as the magneto-rheological fluid 20b.

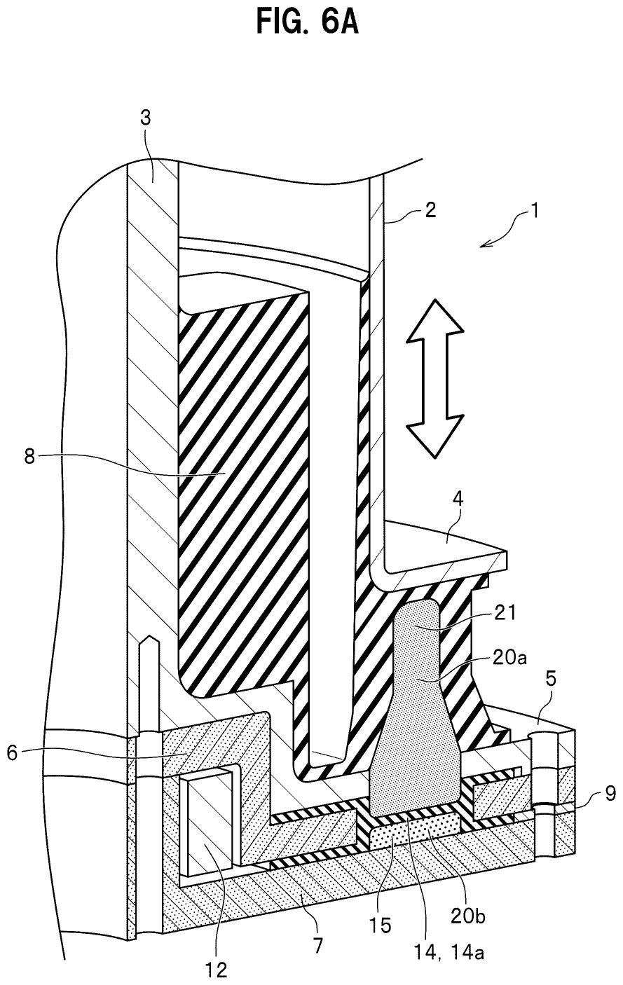

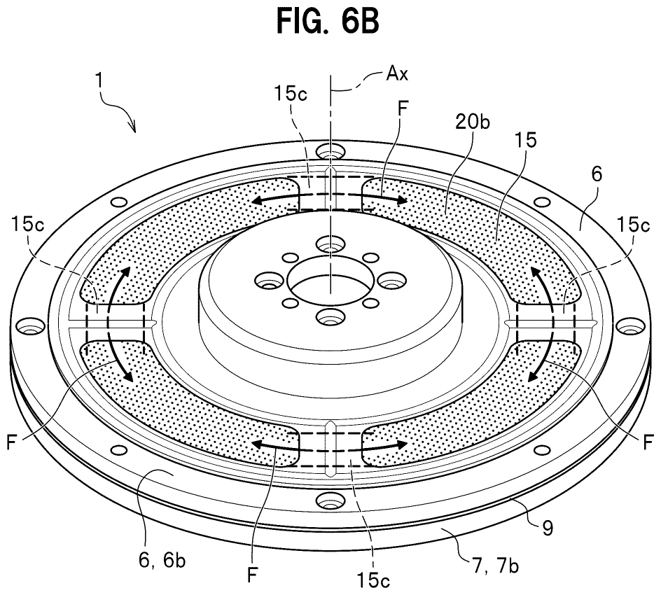

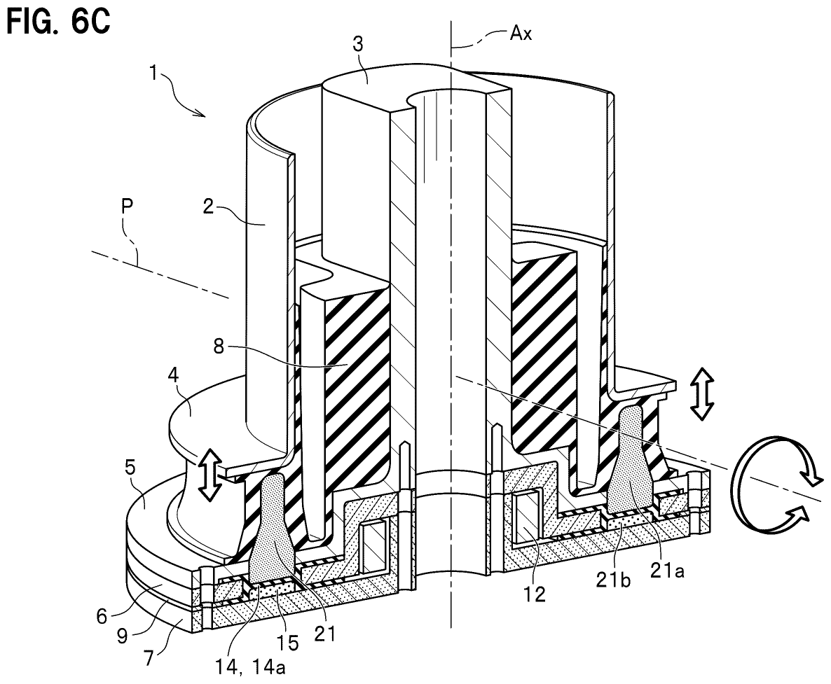

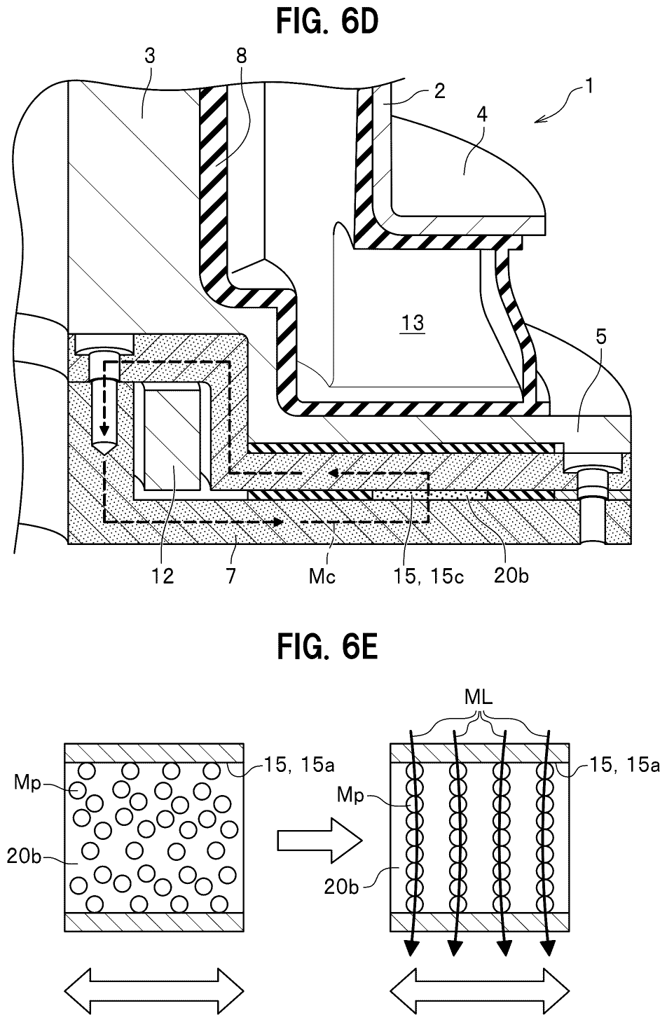

As shown in FIG. 3, the electromagnetic coil 12 (magnetic field generator) is formed in a ring shape. As described later, the electromagnetic coil 12 forms a magnetic circuit Mc (see FIG. 6D) passing the magneto-rheological fluid 20b (see FIG. 6D) in the orifices 15c (see FIG. 6D) by using a generated magnetic field.

As shown in FIG. 3, the spacer 9 is formed of a ring member having an outer diameter that is the same as the outer diameter of the flange portion 7b in the second magnetic body 7.

As shown in FIG. 4B, the spacer 9 is arranged between the outer peripheral edge of the flange portion 6b in the first magnetic body 6 and an outer peripheral edge of the flange portion 7b in the second magnetic body 7.

The spacer 9 as described above maintains the width, in the axial direction, of the orifices 15c formed between the flange portion 6b and the flange portion 7b at a constant width.

### <<Operations of Active Vibration Control Device>>

Next, operations of the active vibration control device 1 are explained.

FIG. 6A is an operation explanation view of the active vibration control device 1 in the case where vibration or the like is inputted in the axial direction of the active vibration control device 1. FIG. 6B is an operation explanation view of the active vibration control device 1 showing how the magneto-rheological fluid 20b flows in the first fluid chambers 15 in the case where vibration or the like is inputted in the axial direction of the active vibration control device 1. FIG. 6C is an operation explanation view of the active vibration control device 1 in the case where vibration or the like is inputted in such a direction that the inner cylinder 3 of the active vibration control device 1 is twisted relative to the outer cylinder 2. FIG. 6D is an operation explanation view of the active vibration control device 1 showing how the magnetic circuit Mc is formed by the magnetic field generated by the electromagnetic coil 12. FIG. 6E is a schematic diagram showing operations of a magnetic powder Mp in the case where the magnetic field is applied to the orifice 15c of the first fluid chambers 15.

First, operations of the active vibration control device 1 in a state where the electromagnetic coil 12 (see FIG. 6A) is not energized are explained.

As shown in FIG. 4C, in the active vibration control device 1, the inner cylinder 3 is elastically supported by the elastic body 8 in the outer cylinder 2.

Accordingly, as shown in FIG. 6A, in the active vibration control device 1, when an external force such as load or vibration amplitude is inputted into the inner cylinder 3 in the axial direction as shown by the white arrow, the positions of the inner cylinder 3 and the outer cylinder 2 relative to each other change.

Assume a case where the inner cylinder 3 is displaced in a downward direction in the sheet of FIG. 6A out of the white arrow directions in which the external force is applied. In this case, the elastic body 8 defining the second fluid chambers 21 is pressed between the outer cylinder flange 4 and the inner cylinder flange 5. The fluid pressure of the fluid 20a in the second fluid chambers 21 thereby increases.

When the fluid pressure of the fluid 20a in the second fluid chambers 21 increases, the fluid 20a pushes the flexible member main body 14a of the flexible member 14 toward the first fluid chambers 15.

As described above, the first fluid chambers 15a shown in FIG. 5B are adjacent to the second fluid chambers 21 (see FIG. 4A), and are also connected to the first fluid chambers 15b via the orifices 15c. As described above, the first fluid chambers 15b are adjacent to the air chambers 13 (see FIG. 4C).

Since the air chambers 13 are opened to the atmosphere as shown in FIG. 4B, the flexible member main body 14a of the flexible member 14 partitioning the first fluid chambers 15 and the air chambers 13 from one another as shown in FIG. 4C is pushed toward the air chambers 13.

Assume a case where, in opposite to this, the inner cylinder 3 shown in FIG. 6A is displaced in an upward direction in the sheet of FIG. 6A. In this case, the elastic body 8 defining the second fluid chambers 21 is pulled between the outer cylinder flange 4 and the inner cylinder flange 5. The fluid pressure of the fluid 20a in the second fluid chambers 21 thereby decreases.

When the fluid pressure of the fluid 20a in the second fluid chambers 21 decreases, the fluid 20a pulls the flexible member main body 14a of the flexible member 14 toward the second fluid chambers 21.

The flexible member main body 14a of the flexible member 14 shown in FIG. 4C is thereby pulled toward the first fluid chambers 15.

Then, the magneto-rheological fluid 20b filling the first fluid chambers 15 generates flows F passing the orifices 15c as shown in FIG. 6B with such displacement of the flexible member main body 14a caused by the displacement of the inner cylinder 3 shown in FIG. 6A.

The active vibration control device 1 exhibits a damping characteristic for inputted vibration or the like by using fluid resistance that is generated when the magneto-rheological fluid 20b passes the orifices 15c.

Moreover, as described above, the inner cylinder 3 (see FIG. 4C) elastically supported inside the outer cylinder 2 (see FIG. 4C) can swing inside the outer cylinder 2.

In FIG. 6C, there is assumed to be an axis P that is orthogonal to the axis Ax and that extends along the longer direction of the oval-track shaped cross section of the inner cylinder 3. FIG. 6C shows a state of the active vibration control device 1 in which the inner cylinder 3 turns about the axis P.

As shown in FIG. 6C, the second fluid chambers 21 are formed on the flat outer surfaces of the inner cylinder 3 described above, specifically, on the sides where the inner cylinder 3 is not directly bonded to the inner peripheral surface of the outer cylinder 2 by the vulcanization bonding of the elastic body 8.

Meanwhile, when the inner cylinder 3 is displaced by an external force such as vibration or the like to be twisted inside the outer cylinder 2 as shown in FIG. 6C, the inner cylinder 3 is turned about the axis P. In this case, portions of the outer cylinder flange 4 including the second fluid chambers 21 are alternately displaced in directions opposite to each other to approach or move away from the inner cylinder flange 5 on both sides of the axis Ax. The pressure of the fluid 20a in each second fluid chamber 21 increases or decreases.

As shown in FIG. 6B, the magneto-rheological fluid 20b filling the first fluid chambers 15 thereby generates the flows F passing the orifices 15c.

The active vibration control device 1 exhibits the damping characteristic for inputted vibration or the like by using the fluid resistance that is generated when the magneto-rheological fluid 20b passes the orifices 15c.

Next, operations of the active vibration control device 1 (see FIG. 6D) in a state where the electromagnetic coil 12 (see FIG. 6D) is energized are explained.

As shown in FIG. 6D, the magnetic circuit Mc passing the magneto-rheological fluid 20b in the orifices 15c is formed in the first magnetic body 6 and the second magnetic body 7 by using the magnetic field generated by the energized electromagnetic coil 12.

As shown in a left diagram of FIG. 6E, in a state where no magnetic field is applied, the dispersed state of the magnetic powder Mp is maintained in the magneto-rheological fluid 20b in the orifices 15c of the first fluid chambers 15, and the magneto-rheological fluid 20b has predetermined fluidity.

Meanwhile, as shown in a right diagram of FIG. 6E, when the magnetic circuit Mc (see FIG. 6E) is formed by using the generated magnetic field, the magnetic powder Mp is aligned along magnetic fluxes ML. The apparent viscosity of the magneto-rheological fluid 20b thereby increases, and the aligned magnetic powder Mp serves as a valve element to generate fluid resistance in the orifices 15c.

The active vibration control device 1 exhibits the damping characteristic for inputted vibration or the like by using this fluid resistance of the magneto-rheological fluid 20b in the orifices 15c.

Moreover, this damping characteristic for vibration or the like can be varied by controlling a value of a current flowing in the electromagnetic coil 12 (see FIG. 6D) depending on the magnitude of the inputted vibration or the like.

The active vibration control device 1 of the present embodiment is configured such that, when load or vibration amplitude is inputted into the outer cylinder 2 or the inner cylinder 3 from the outside in the axial direction or when load or vibration amplitude is inputted from the outside to twist the inner cylinder 3 in the outer cylinder 2, the flows of the magneto-rheological fluid 20b are generated in the first fluid chambers 15 depending on a change of the fluid pressure of the fluid 20a in the second fluid chambers 21. Moreover, the active vibration control device 1 controls the damping characteristic for vibration or the like by using the magnitude of the magnetic field (magnetic flux density) applied to the orifices 15c of the first fluid chambers 15.

According to the active vibration control device 1 as described above, the flows of the magneto-rheological fluid 20b are generated in the first fluid chambers 15 by the fluid pressure change of the fluid 20a in the second fluid chambers 21, unlike in a conventional active vibration control device (for example, see JP2021-71117A) that directly changes an input of vibration or the like from the outside to a flow of a magneto-rheological fluid.

### <<Operations and Effects>>

Next, operations and effects provided by the active vibration control device 1 according to the present embodiment are explained.

The active vibration control device 1 of the present embodiment includes the outer cylinder 2, the inner cylinder 3 arranged on the inner peripheral side of the outer cylinder 2, the electromagnetic coil 12 (magnetic field generator) configured to generate the magnetic field, the first magnetic body 6 and the second magnetic body 7 forming the magnetic circuit Mc created by the magnetic field, the first fluid chambers 15 filled with the magneto-rheological fluid 20b, and the second fluid chambers 21 adjacent to the first fluid chambers 15 and filled with the fluid 20a.

Moreover, the active vibration control device 1 includes the outer cylinder flange 4 extending outward in the radial direction from the one end of the outer cylinder 2 in the axial direction and the inner cylinder flange 5 extending outward in the radial direction from the inner cylinder 3 and arranged to be separated from the outer cylinder flange 4 in the axial direction.

Furthermore, the first fluid chambers 15 and the second fluid chambers 21 of the active vibration control device 1 are partitioned from one another in the axial direction by the flexible member 14.

Moreover, the second fluid chambers 21 of the active vibration control device 1 are formed to be sandwiched between the inner cylinder flange 5 and the outer cylinder flange 4.

Furthermore, portions of the first fluid chambers 15 form the flow passages of the magneto-rheological fluid 20b located on the magnetic circuit Mc.

Specifically, the active vibration control device 1 of the present embodiment is configured such that, when external force such as vibration is inputted in the axial direction via at least one of the outer cylinder 2 and the inner cylinder 3, displacement of the outer cylinder flange 4 and the inner cylinder flange 5 relative to each other changes the fluid pressure of the fluid 20a filling the insides of the second fluid chambers 21.

As described above, the active vibration control device 1 of the present embodiment is configured such that the fluid pressure change of the fluid 20a in the second fluid chambers 21 generates the flows of the magneto-rheological fluid 20b in the first fluid chambers 15, unlike in the conventional active vibration control device (for example, see JP2021-71117A) in which the input of vibration or the like from the outside is directly changed to the flows of the magneto-rheological fluid.

According to the active vibration control device 1 as described above, it is possible to change stiffness while maintaining preferable responsiveness to the vibration or the like inputted in the axial direction and the vibration or the like by which the inner cylinder 3 is twisted in the outer cylinder 2.

Moreover, according to the active vibration control device 1 as described above, it is possible to improve the responsiveness to the inputted vibration or the like by increasing the capacities of the second fluid chambers 21 filled with the fluid 20a without increasing the capacities of the first fluid chambers 15 filled with the magneto-rheological fluid 20b.

Furthermore, according to the active vibration control device 1, since the capacities of the fluid chambers (first fluid chambers 15) filled with the magneto-rheological fluid 20b can be made relatively small unlike in the conventional active vibration control device (for example, see JP2021-71117A), a usage amount of the magneto-rheological fluid 20b that includes the magnetic powder Mp and that is relatively heavy and expensive can be reduced.

Moreover, according to the active vibration control device 1, since the capacities of the fluid chambers (first fluid chambers 15) filled with the magneto-rheological fluid 20b can be made relatively small unlike in the conventional active vibration control device (for example, see JP2021-71117A), an absolute amount of the precipitating magnetic powder Mp included in the magneto-rheological fluid 20b can be reduced.

Furthermore, according to the active vibration control device 1, since the capacities of the fluid chambers (first fluid chambers 15) filled with the magneto-rheological fluid 20b can be made relatively small, the magnetic powder Mp can be redispersed by an action of the flows F of the magneto-rheological fluid 20b kicking up the precipitating magnetic powder Mp.

Moreover, according to the active vibration control device 1, since the precipitation of the magnetic powder Mp due to aging can be suppressed, a preferable damping performance for vibration or the like can be maintained.

Moreover, in the active vibration control device 1 of the present embodiment, the multiple second fluid chambers 21 (see FIG. 5A) and the multiple air chambers 13 (see FIG. 5A) are alternately arranged in the circumferential direction, the multiple first fluid chambers 15 (see FIG. 5B) are provided adjacent to the second fluid chambers 21 and the air chambers 13 in the axis Ax direction to correspond to these chambers, and the multiple first fluid chambers 15 are connected to one another in the circumferential direction by the orifices 15c (see FIG. 5B).

In other words, the active vibration control device 1 is specifically configured as follows. At least four first fluid chambers 15a and 15B (see FIG. 5B) are provided along the circumferential direction, the second fluid chambers 21 (see FIG. 5A) are provided at positions adjacent to the two first fluid chambers 15a, 15a (see FIG. 5B), located on the opposite sides with respect to the axis Ax, among the at least four first fluid chambers 15a and 15b (see FIG. 5B), and the first fluid chambers 15a adjacent to the second fluid chambers 21 and the first fluid chambers 15b not adjacent to the second fluid chambers 21 are connected to one another by the orifices 15c located on the magnetic circuit Mc.

According to the active vibration control device 1, the stiffness can be varied not only for the input of external force in the axis Ax direction but also for the input of external force that causes displacement (twisting) in which the inner cylinder 3 is tilted in a direction in which the paired second fluid chambers 21 are aligned while being centered around the axis Ax (for example, left-right direction in the case where the active vibration control device 1 is used as the bush 35 of the subframe 30 shown in FIG. 1).

Moreover, according to the active vibration control device 1 as described above, since the first fluid chambers 15a are connected to the first fluid chambers 15b not adjacent to the second fluid chambers 21, that is the first fluid chambers 15b adjacent to the air chambers 13 via the orifices 15c, displacement of the flexible member 14 (flexible member main body 14a) is not hindered. The flows F of the magneto-rheological fluid 20b between the first fluid chambers 15a and 15b via the orifices 15c are generated with good sensitivity to the input of external force.

Furthermore, the active vibration control device 1 described above further includes the elastic body 8 arranged in a region from a portion between the outer cylinder 2 and the inner cylinder 3 to a portion between the outer cylinder flange 4 and the inner cylinder flange 5, the second fluid chambers 21 are formed in the elastic body 8 and the air chambers 13 are further formed in the elastic body 8, and the first fluid chambers 15 and the air chambers 13 are partitioned from one another in the axis Ax direction by the flexible member 14 (flexible member main body 14a).

According to the active vibration control device 1 as described above, a preferable damping performance for vibration or the like can be exhibited by an action of the elastic body 8 itself.

Moreover, according to the active vibration control device 1 as described above, the flows F of the magneto-rheological fluid 20b are more effectively generated in response to the input of external force by the action of the elastic body 8 itself.

Furthermore, according to the active vibration control device 1 described above, the first fluid chambers 15b not adjacent to the second fluid chambers 21 are adjacent to the air chambers 13 via the flexible member 14 (flexible member main body 14a), and the air chambers 13 include the connection walls 13a that extend in the circumferential direction on the outer peripheral side of the flexible member 14 (flexible member main body 14a) and that are connected to the outer peripheral walls 21a forming the second fluid chambers 21. According to the active vibration control device 1 as described above, the connection walls 13a can prevent entrance of foreign objects such as dust into the air chambers 13.

The active vibration control device 1 of the present embodiment as described above can be preferably used instead of various conventional mount bushes and suspension bushes that need to be carefully chosen with a safety performance, a motion performance, a comfort performance, a rideability performance, and the like taken into consideration.

Although the present embodiment has been explained above, the present invention is not limited to the above embodiment and can be carried out in various modes.

In the above-mentioned embodiment, as shown in FIG. 5A, the active vibration control device 1 including two second fluid chambers 21 and two air chambers 13 is explained. Moreover, the second fluid chambers 21 and the air chambers 13 are alternately arranged side by side in the circumferential direction.

As shown in FIG. 5B, this active vibration control device 1 includes the two first fluid chambers 15a adjacent to the second fluid chambers 21 (see FIG. 5A) in the axis Ax direction and the two first fluid chambers 15b adjacent to the air chambers 13 (see FIG. 5A) in the axis Ax direction.

Moreover, as shown in FIG. 5B, the first fluid chambers 15a and the first fluid chambers 15b are alternately arranged side by side in the circumferential direction, and are connected to one another by the four orifices 15c forming portions of the first fluid chambers 15.

In other words, in the active vibration control device 1 of the above-mentioned embodiment, the multiple second fluid chambers 21 and the multiple air chambers 13 are alternately arranged side by side in the circumferential direction, the multiple first fluid chambers 15a and 15b are provided adjacent to the second fluid chambers 21 and the air chambers 13 in the axis Ax direction to correspond to these chambers, and the multiple first fluid chambers 15a and 15b are connected to one another in the circumferential direction by the orifices 15c.

### First Modification Example

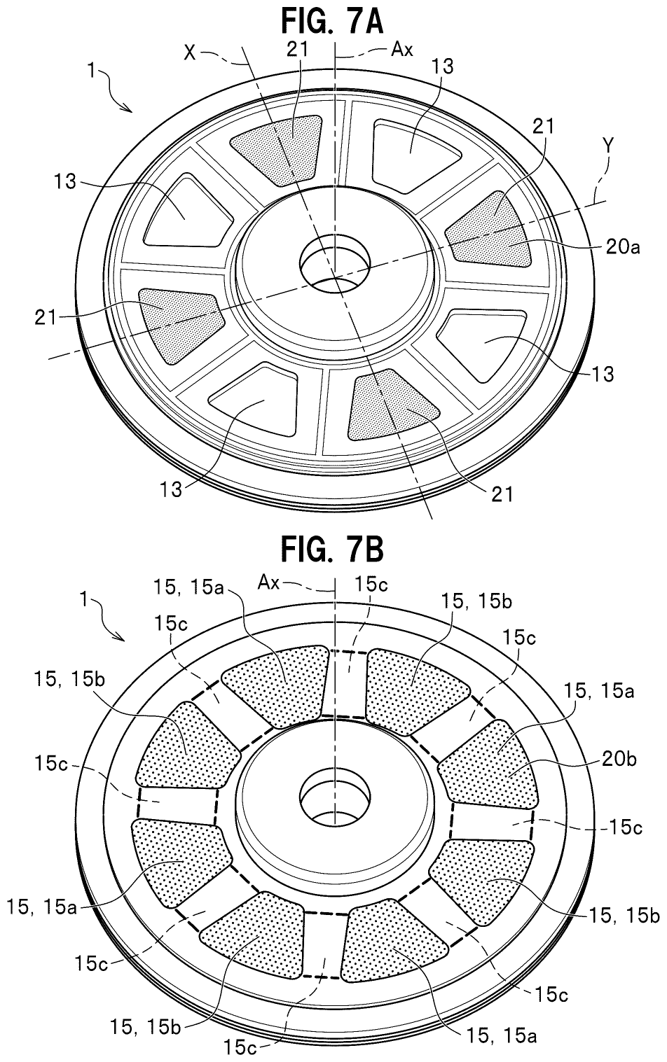

FIG. 7A is an arrangement diagram of the second fluid chambers 21 and the air chambers 13 in the active vibration control device 1 according to a first modified example. FIG. 7B is an arrangement diagram of the first fluid chambers 15a and 15b in the active vibration control device 1 according to the first modified example. Note that, in the first modified example, the same components as those in the above-mentioned embodiment are denoted by the same reference numerals, and detailed explanation thereof is omitted.

As shown in FIG. 7B, the active vibration control device 1 according to the first modified example includes eight first fluid chambers 15 (first fluid chambers 15a and 15b) arranged side by side along the circumferential direction.

Moreover, as shown in FIG. 7A, the second fluid chambers 21 of the active vibration control device 1 according to the first modified example are located on two straight lines X and Y orthogonal to the axis Ax. Specifically, the second fluid chambers (see FIG. 7A) are provided at positions that are located on the two straight lines X and Y orthogonal to the axis Ax and that are adjacent to four first fluid chambers 15a in the axis Ax direction as shown in FIG. 7B.

Furthermore, as shown in FIG. 7A, the air chambers 13 of the active vibration control device 1 according to the first modified example are arranged alternately with the second fluid chambers 21 in the circumferential direction.

Moreover, as shown in FIG. 7B, in the active vibration control device 1 according to the first modified example, the first fluid chambers 15a and the first fluid chambers 15b adjacent to the air chambers 13 in the axis Ax direction to correspond to the air chambers 13 are connected to one another by the orifices 15c that are portions of the first fluid chambers 15. Note that the first fluid chambers 15b correspond to the “first fluid chambers not adjacent to the second fluid chambers” in the scope of claims.

Furthermore, the orifices 15c are located on the magnetic circuit Mc (see FIG. 6D) as in the above-mentioned embodiment.

Note that reference numeral 20a in FIG. 7A denotes the fluid, and reference numeral 20b in FIG. 7B denotes the magneto-rheological fluid.

According to the active vibration control device 1 of the first modified example as described above, it is possible to vary the stiffness with better responsiveness to the input of external force that causes twisting of the inner cylinder 3 in the outer cylinder 2.

### Second Modified Example

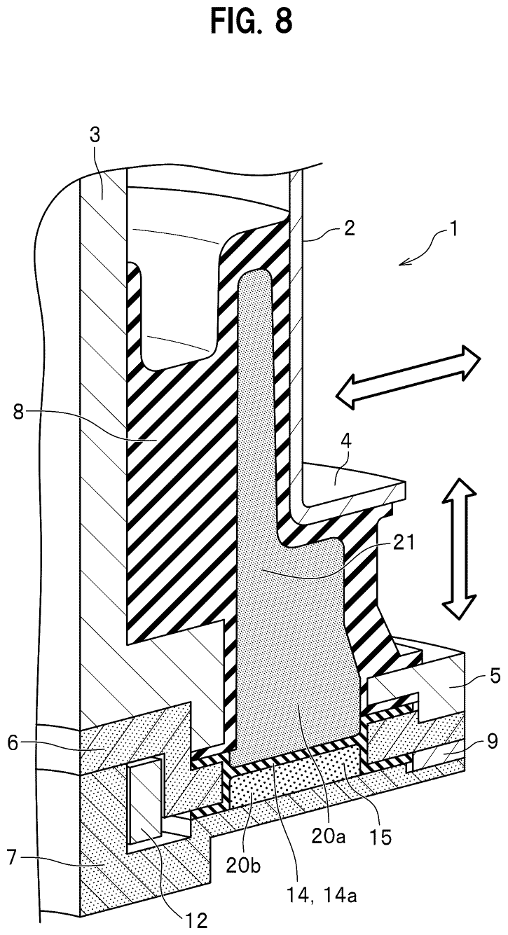

FIG. 8 is a configuration explanation diagram of the active vibration control device 1 according to a second modified example. Note that, in the second modified example, the same components as those in the above-mentioned embodiment are denoted by the same reference numerals, and detailed explanation thereof is omitted.

As shown in FIG. 6A, in the active vibration control device 1 of the above-mentioned embodiment, the second fluid chambers 21 are formed only between the outer cylinder flange 4 and the inner cylinder flange 5, and are not formed between the outer cylinder 2 and the inner cylinder 3.

Meanwhile, as shown in FIG. 8, in the active vibration control device 1 according to the second modified example, the second fluid chambers 21 are formed to extend to an inner portion of the elastic body 8 that is arranged between the outer cylinder 2 and the inner cylinder

Note that reference numeral 14a in FIG. 8 denotes the flexible member main body of the flexible member 14 partitioning the first fluid chambers 15 and the second fluid chambers 21 from one another, reference numeral 6 denotes the first magnetic body, reference numeral 7 denotes the second magnetic body, reference numeral 12 denotes the electromagnetic coil (magnetic field generator), reference numeral 9 denotes the spacer, reference numeral 20a denotes the fluid, and reference numeral 20b denotes the magneto-rheological fluid.

According to the active vibration control device 1 in the second modified example as described above, the fluid pressure of the fluid 20a in the second fluid chambers 21 changes with good sensitivity to not only the displacement in the axial direction but also the displacement of the outer cylinder 2 and the inner cylinder 3 relative to each other in the radial direction (direction perpendicular to the axis) as shown by the white arrows in FIG. 8. The active vibration control device 1 can vary the stiffness with good sensitivity to also the input of external force in the axial direction and the radial direction (direction perpendicular to the axis).

### Third Modified Example

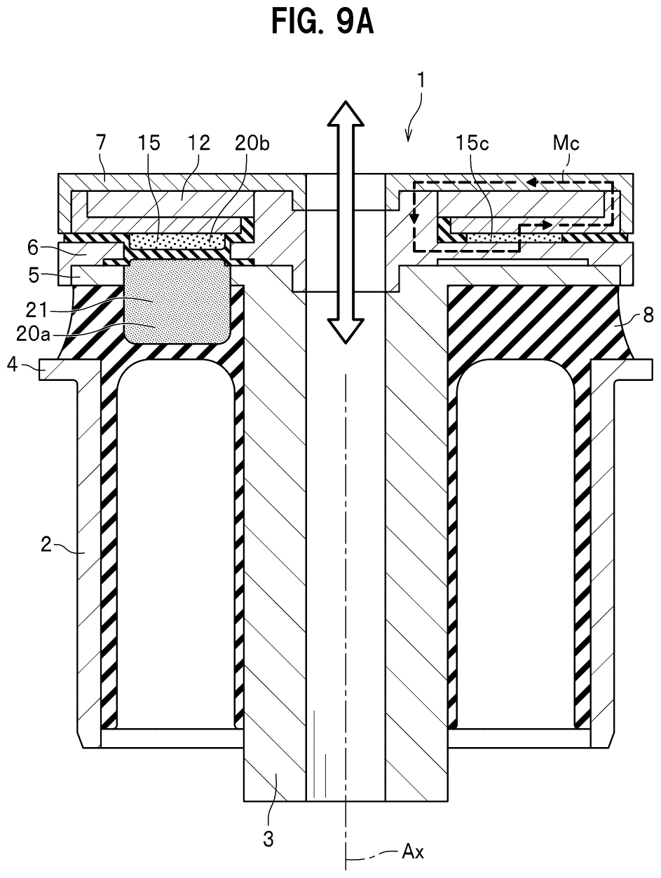

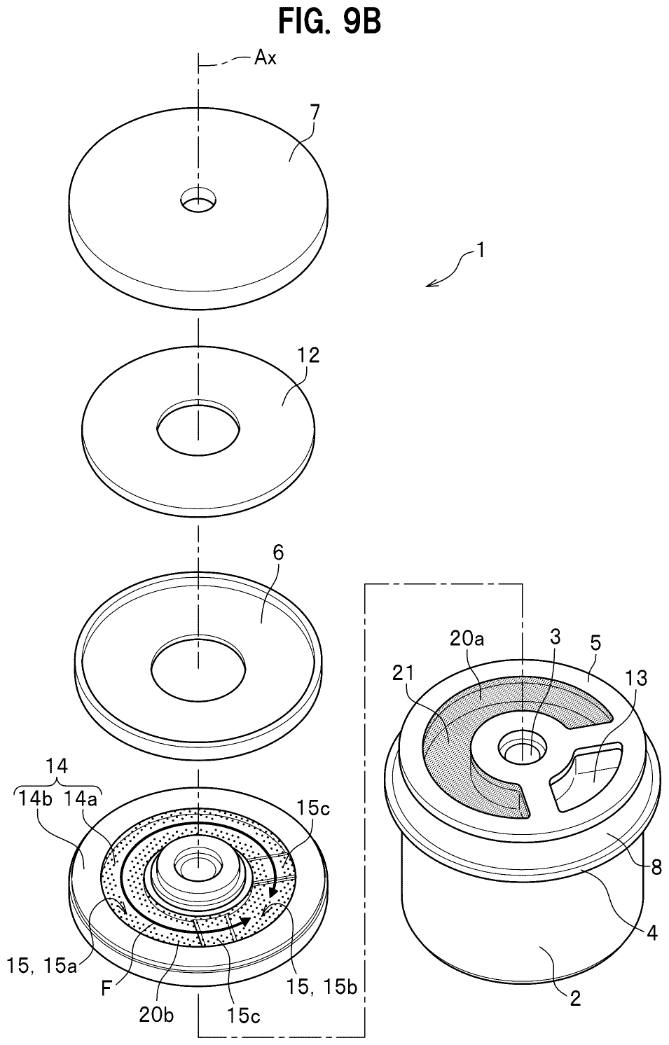

FIG. 9A is a vertical cross-sectional view of the active vibration control device 1 according to a third modified example. FIG. 9B is an exploded perspective view of the active vibration control device 1 according to the third modified example. Note that, in the third modified example, the same components as those in the above-mentioned embodiment are denoted by the same reference numerals, and detailed explanation thereof is omitted.

As shown in FIG. 9A, in the active vibration control device 1 according to the third modified example, when the inner cylinder 3 is displaced in the axis Ax direction inside the outer cylinder 2, the fluid pressure of the fluid 20a in the second fluid chamber 21 formed in the elastic body 8 sandwiched between the outer cylinder flange 4 and the inner cylinder flange 5 changes.

In the first fluid chamber 15 formed adjacent to the second fluid chamber 21 in the axis Ax direction via the flexible member 14, the fluid pressure of the magneto-rheological fluid 20b filling the first fluid chamber 15 changes depending on the change of the fluid pressure of the fluid 20a in the second fluid chamber 21.

Meanwhile, as shown in FIG. 9B, in the active vibration control device 1 according to the third modified example, one second fluid chamber 21 and one air chamber 13 are arranged side by side in the circumferential direction, unlike in the active vibration control device 1 (see FIG. 5A) of the above-mentioned embodiment.

Moreover, the active vibration control device 1 according to the third modified example is provided with one first fluid chamber 15a that is adjacent to the second fluid chamber 21 in the axis Ax direction to correspond to the second fluid chamber 21.

Furthermore, the active vibration control device 1 according to the third modified example is provided with one first fluid chamber 15b that is adjacent to the air chamber 13 in the axis Ax direction to correspond to the air chamber 13.

Moreover, the first fluid chambers 15a and 15b are connected to each other in the circumferential direction by two orifices 15c.

In the active vibration control device 1 according to the third modified example, when the inner cylinder 3 is displaced in the axis Ax direction as shown in FIG. 9A, the flows F of the magneto-rheological fluid 20b between the first fluid chambers 15a and 15b via the orifices 15c are generated as shown in FIG. 9B.

The active vibration control device 1 exhibits the damping characteristic for inputted vibration or the like by using the flow resistance generated when the magneto-rheological fluid 20b passes the orifices 15c.

Moreover, as shown in FIG. 9A, in the active vibration control device 1, the magnetic circuit Mc passing the magneto-rheological fluid 20b in the orifices 15c is formed in the first magnetic body 6 and the second magnetic body 7 by using the magnetic field of the energized electromagnetic coil 12 (magnetic field generator).

Note that reference numeral 2 in FIG. 9B denotes the outer cylinder, reference sign 3 denotes the inner cylinder, reference sign 4 denotes the outer cylinder flange, reference sign 5 denotes the inner cylinder flange, reference sign 8 denotes the elastic body, and reference sign 21 denotes the second fluid chamber filled with the fluid 20a.

Moreover, reference sign 14a in FIG. 9B denotes the flexible member main body of the flexible member 14, reference sign 14b denotes the supporting portion of the flexible member 14, reference sign 6 denotes the first magnetic body, reference sign 7 denotes the second magnetic body, and reference sign 12 denotes the electromagnetic coil (magnetic field generator).

According to the active vibration control device 1 of the third modified example as described above, the stiffness against the external input in the axial direction can be varied in a simpler configuration.

What is claimed is:

1. An active vibration control device comprising:
an outer cylinder;
an inner cylinder arranged on an inner peripheral side of the outer cylinder;
a magnetic field generator configured to generate a magnetic field;
a magnetic body forming a magnetic circuit created by the magnetic field;
a first fluid chamber filled with a magneto-rheological fluid;
a second fluid chamber adjacent to the first fluid chamber and filled with a fluid;
an outer cylinder flange extending outward in a radial direction from one end of the outer cylinder in an axial direction; and
an inner cylinder flange extending outward in the radial direction from the inner cylinder and arranged to be separated from the outer cylinder flange in the axial direction, wherein
the first fluid chamber and the second fluid chamber are partitioned from each other in the axial direction by a flexible member,
the second fluid chamber is formed to be sandwiched between the inner cylinder flange and the outer cylinder flange, and
portions of the first fluid chamber form flow passages of the magneto-rheological fluid that are located on the magnetic circuit.

2. The active vibration control device according to claim 1, wherein
at least four of the first fluid chambers are provided along a circumferential direction,
the second fluid chamber is provided at a position adjacent to each of two first fluid chambers, located on opposite sides with respect to an axis of the inner cylinder, among the at least four of the first fluid chambers, and
the first fluid chambers adjacent to the second fluid chambers and the first fluid chambers not adjacent to the second fluid chambers are connected to one another by orifices that are portions of the first fluid chambers located on the magnetic circuit.

3. The active vibration control device according to claim 2, wherein
at least eight of the first fluid chambers are provided along the circumferential direction,
the second fluid chambers are provided at positions adjacent to four of the first fluid chambers located on two straight lines orthogonal to the axis of the inner cylinder, and
the first fluid chambers adjacent to the second fluid chambers and the first fluid chambers not adjacent to the second fluid chambers are connected to one another by orifices that are portions of the first fluid chambers located on the magnetic circuit.

4. The active vibration control device according to claim 1, further comprising an elastic body arranged in a region from a portion between the outer cylinder and the inner cylinder to a portion between the outer cylinder flange and the inner cylinder flange, wherein
the second fluid chamber is formed in the elastic body and an air chamber is further formed in the elastic body, and
the first fluid chamber and the air chamber are partitioned from each other in the axial direction by the flexible member.

5. The active vibration control device according to claim 2, wherein
the first fluid chambers not adjacent to the second fluid chambers are adjacent to air chambers via the flexible member, and
the air chambers include connection walls that extend in the circumferential direction on an outer peripheral side of the flexible member and that are connected to outer peripheral walls forming the second fluid chambers.

6. The active vibration control device according to claim 3, wherein
the first fluid chambers not adjacent to the second fluid chambers are adjacent to air chambers via the flexible member, and
the air chambers include connection walls that extend in the circumferential direction on an outer peripheral side of the flexible member and that are connected to outer peripheral walls forming the second fluid chambers.

7. The active vibration control device according to claim 1, wherein the second fluid chamber extends to a position between the outer cylinder and the inner cylinder.

8. The active vibration control device according to claim 2, wherein the second fluid chamber extends to a position between the outer cylinder and the inner cylinder.

9. The active vibration control device according to claim 3, wherein the second fluid chamber extends to a position between the outer cylinder and the inner cylinder.
